(19) United States
(12) Patent Application Publication
(10) Pub. No.: US 2015/0017505 A1
(43) Pub. Date: Jan. 15, 2015

(54) BATTERY PACK

(71) Applicant: Samsung SDI Co., Ltd., Yongin-si (KR)

(72) Inventors: Hee-Youn Won, Yongin-si (KR); Dae-Yon Moon, Yongin-si (KR)

(73) Assignee: Samsung SDI Co., Ltd., Yongin-si (KR)

(21) Appl. No.: 14/162,371

(22) Filed: Jan. 23, 2014

(30) Foreign Application Priority Data
Jul. 9, 2013 (KR) 10-2013-0080323

(51) Int. Cl. H01M 2/20; H01M 10/42; H01M 2/10

(52) U.S. Cl. CPC H01M 2/204; H01M 2/1022; H01M 10/425; H01M 2220/30; H01M 2010/4271
USPC 429/121

(57) ABSTRACT

Provided is a battery pack. In one embodiment, the battery pack includes a plurality of unit batteries located side-by-side, a connection substrate for connecting the unit batteries to each other in either series or parallel, a protection circuit module electrically coupled to the connection substrate, and a first connection tab and a second connection tab located on the connection substrate. The first and second connection tabs electrically couple each of the unit batteries to the connection substrate. At least one of the first connection tab and the second connection tab includes one end that is connected to the unit batteries and another end that is attached to a first surface of the connection substrate and a side of the connection substrate that is approximately perpendicular to the first surface.

### CROSS-REFERENCE TO RELATED APPLICATION

This application claims priority to and the benefit of Korean Patent Application No. 10-2013-0080323, filed on Jul. 9, 2013, in the Korean Intellectual Property Office, the entire contents of which are incorporated herein by reference.

### BACKGROUND

1. Field

One or more embodiments of the present invention relate to a battery pack that includes a plurality of unit batteries.

2. Description of the Related Art

In contrast to a primary battery that cannot be charged, a secondary battery refers to a chargeable and dischargeable battery. Secondary batteries are widely used in energy storage systems, as well as small advanced electronic apparatuses, such as cellphones, personal digital assistants (PDA), laptop computers, etc.

A secondary battery may be used in the form of a single battery or a plurality of electrically-connected batteries, depending upon the type of electronic apparatus in which the secondary battery is used. For example, a small device, such as a cellphone, may operate for a determined period of time with a power and a capacity that may be provided by one battery. On the contrary, in the case of a medium or large apparatus, such as a laptop computer, a portable digital video disc (DVD) player, or a small PC, it may be desirable to use a plurality of batteries so as to provide high power and capacity.

A battery pack, in which a plurality of batteries are connected to each other in series and/or parallel and are connected to a protection circuit, may be used in a medium or large apparatus. When a battery pack is manufactured, it is desirable to provide a stable electrical connection between batteries, so as to ensure sufficient power and capacity.

### SUMMARY

Additional aspects will be set forth in part in the description which follows and, in part, will be apparent from the description, or may be learned by practice of the presented embodiments.

According to one or more embodiments of the present disclosure, a battery pack includes a plurality of unit batteries located side-by-side, a connection substrate for connecting the unit batteries to each other in either series or parallel, a protection circuit module electrically coupled to the connection substrate, and a first connection tab and a second connection tab located on the connection substrate. The first and second connection tabs electrically connect each of the unit batteries to the connection substrate. At least one of the first connection tab and the second connection tab includes one end that is connected to the unit batteries and one other end that is attached to a first surface of the connection substrate and a side of the connection substrate that is approximately perpendicular to the first surface.

In one embodiment, the connection substrate includes a circuit pattern for coupling the unit batteries to each other in either series or parallel, and a part of the circuit pattern is exposed on the first surface of the connection substrate so as to form a connection pad.

In one embodiment, a part of the other end of the at least one of the first connection tab and the second connection tab, which is attached to the first surface of the connection substrate, is attached to the connection pad.

In one embodiment, a part of the other end of the at least one of the first connection tab and the second connection tab, which is attached to the first surface of the connection substrate, is attached to the first surface of the connection substrate by an adhesive material that includes lead (Pb).

In one embodiment, the at least one of the first connection tab and the second connection tab includes a connection part that is connected to the unit batteries, a fixing part that includes a first part that is attached to the first surface of the connection substrate and a second part that is perpendicular to the first part and attached to the side of the connection substrate, and a joint part that connects the connection part to the fixing part.

In one embodiment, the first surface of the connection substrate includes a connection pad, and the first part of the fixing part is attached to the connection pad. In one embodiment, the joint part is bent so that the first surface of the connection substrate and an upper surface of the unit batteries, to which the connection part is attached, face each other.

In one embodiment, the joint part is offset toward one side of an axis that passes through a center of the connection part and the fixing part, and the joint part couples the connection part and the fixing part together as one unitary body.

In one embodiment, the fixing part includes a third part that is bent to be approximately perpendicular to the second part of the fixing part. The third part is attached to a lower surface of the connection substrate.

In one embodiment, the connection substrate includes a groove that is formed in the side of the connection substrate. The groove corresponds to the second part of the fixing part and accommodates the second part.

According to one or more embodiments of the present invention, a battery pack includes a plurality of unit batteries that each include a first electrode and a second electrode on an upper surface. In one embodiment, the unit batteries are located side-by-side. The battery pack also includes a connection substrate for electrically coupling the unit batteries to each other, a protection circuit module that is electrically coupled to the connection substrate, a first connection tab located on the connection substrate and electrically coupling the first electrode to the connection substrate, and a second connection tab located on the connection substrate and electrically coupling the second electrode to the connection substrate. The second electrode tab includes a connection part connected to the second electrode and a fixing part attached to the connection substrate. The fixing part includes a first part that is attached to a first surface of the connection substrate, and a second part that is bent to be approximately perpendicular to the first part and is attached to a side of the connection substrate.

In one embodiment, the connection substrate includes a circuit pattern for connecting the unit batteries to each other in either series or parallel, and a part of the pattern is exposed on the first surface of the connection substrate so as to form a connection pad.

In one embodiment, the first part of the fixing part is attached to the connection pad.

In one embodiment, an adhesive material that includes lead (Pb) is interposed between the first part and the connection pad.

In one embodiment, the connection substrate includes a groove that is formed in the side of the connection substrate. The groove is configured to accommodate the second part.

In one embodiment, the second connection tab includes a joint part that is bent so that the connection substrate is located on the unit batteries. The joint part couples the connection part to the fixing part.

In one embodiment, the joint part is bent so that the first surface of the connection substrate and an upper surface of the unit batteries face each other.

In one embodiment, the fixing part includes a third part that is bent to be approximately perpendicular to the second part of the fixing part. The third part of the fixing part is attached to a second surface of the connection substrate that is an opposite side of the first surface of the connection substrate.

In one embodiment, the first electrode is a negative electrode of the unit batteries, and the second electrode is a positive electrode of the unit batteries.

In one embodiment, the protection circuit module is bent to be approximately perpendicular to the connection substrate and adjacent to a side of the unit batteries.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic perspective view of a battery pack according to an embodiment of the present disclosure;

FIG. 2 is an exploded perspective view of the battery pack of FIG. 1;

FIG. 3 is a perspective view of a connection substrate and a protection circuit module shown in FIG. 2, as seen from a different viewpoint from FIG. 2;

FIG. 4 is an enlarged perspective view of area IV shown in FIG. 3;

FIG. 5 is an exploded perspective view of FIG. 4; and

FIG. 6 is a schematic exploded perspective view of a circuit board and a connection tab, according to another embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

As aspects of the disclosure allow for various changes and numerous embodiments, particular embodiments will be illustrated in the drawings and described in detail in the written description. However, this is not intended to limit the aspects of the present disclosure to particular modes of practice, and it is to be appreciated that all changes, equivalents, and substitutes that do not depart from the spirit and technical scope of the aspects of the present disclosure are encompassed in the aspects of the present disclosure. In the description of the exemplary embodiments of the present disclosure, certain detailed explanations of related art are omitted when it is deemed that they may unnecessarily obscure the essence of the aspects of the disclosure. While such terms as “first”, “second”, etc., may be used to describe various components, such components must not be limited to the above terms. The above terms are used only to distinguish one component from another. The terms used in the present specification are merely used to describe particular embodiments, and are not intended to limit the aspects of the present disclosure. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

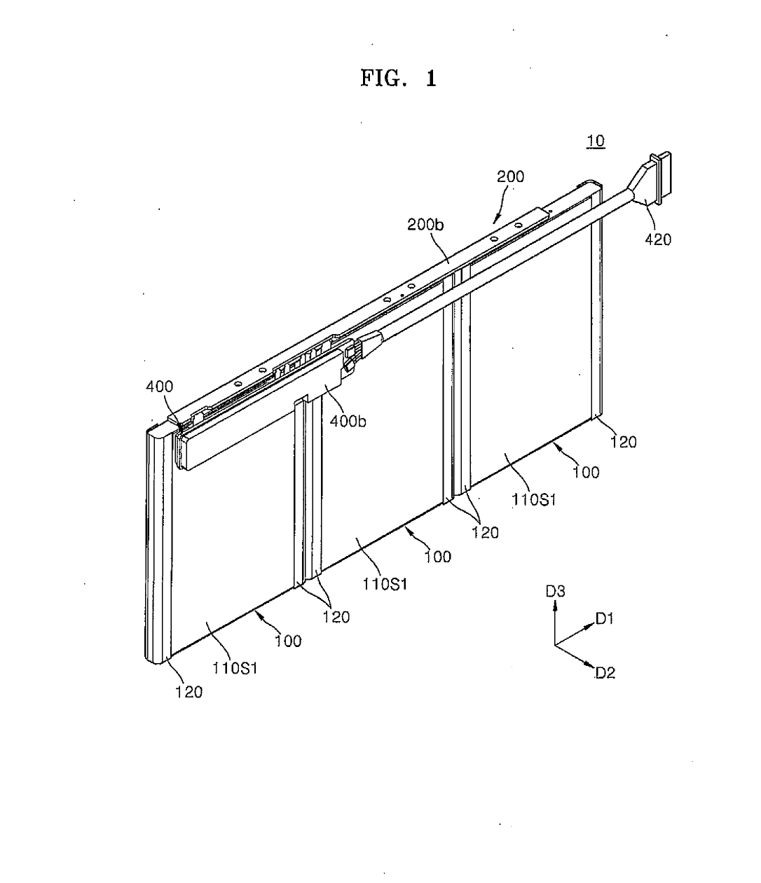

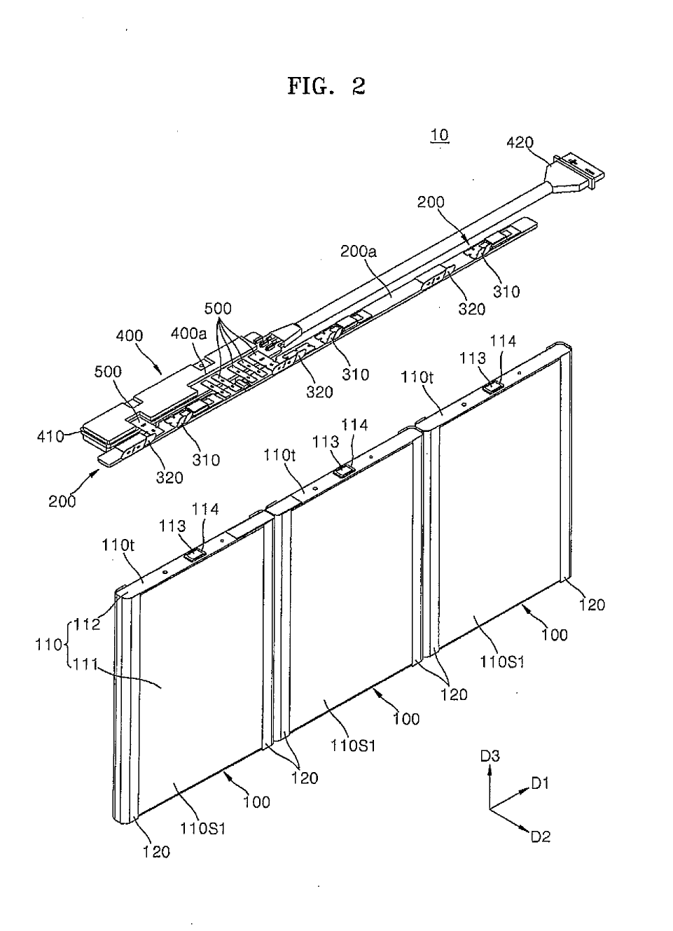

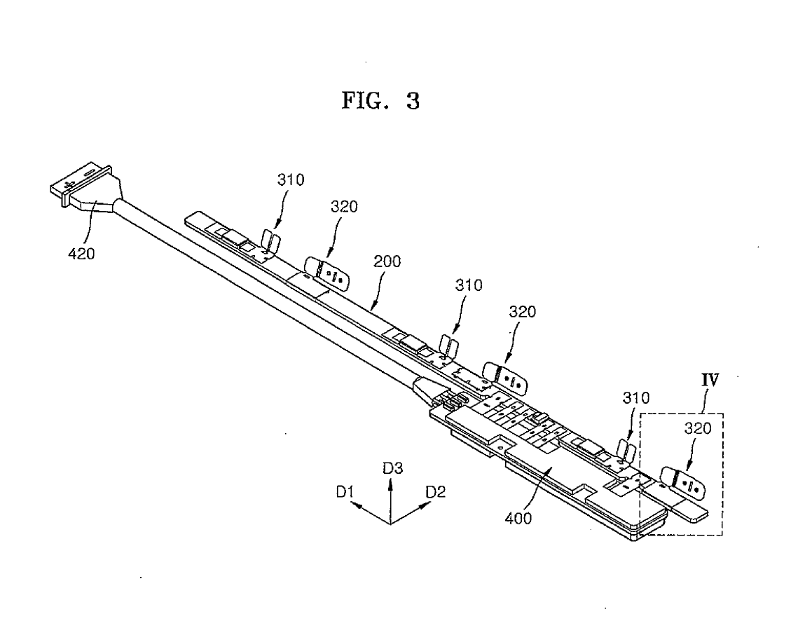

FIG. 1 is a schematic perspective view of a battery pack 10 according to an embodiment of the present invention. FIG. 2 is an exploded perspective view of the battery pack 10 of FIG. 1. FIG. 3 is a perspective view of a connection substrate 200 and a protection circuit module 400 shown in FIG. 2, as seen from a different viewpoint from FIG. 2.

Referring to FIGS. 1 through 3, the battery pack 10 may include a plurality of unit batteries 100, the connection substrate 200 for electrically coupling the plurality of unit batteries 100 to each other, first and second connection tabs 310 and 320, the protection circuit module 400, and leads 500.

The unit batteries 100 may be any suitable type of rechargeable secondary batteries, such as, for instance, lithium-ion batteries. The unit batteries 100 may include an electrode assembly and a case or a can 110 that accommodates the electrode assembly and an electrolyte.

The electrode assembly may be manufactured by stacking a positive electrode plate, a negative electrode plate, and a separator that is interposed therebetween, and then winding the positive electrode plate, the negative electrode plate, and the separator into the form of a jelly roll. The electrode assembly is accommodated in the can 110. The can 100 includes a body 111 having an upper opening, and a cap plate 112 that closes and seals the upper opening of the body 111. The cap plate 112 may be coupled to the body 111 by any suitable means, such as, for instance, welding or bonding. The electrolyte may be injected into the can 110 via an injection hole provided in either the cap plate 112 or the body 111. In one embodiment, the electrolyte may be injected into the can 110 after the cap plate 112 has been coupled to the body 111.

In the illustrated embodiment, the unit batteries 100 may approximately have a rectangular parallelepiped shape which includes an upper surface, a lower surface, a first side and a second side that extend between longer sides of the upper surface and the lower surface and are parallel with each other, and a third side and a fourth side that extend between shorter sides of the upper surface and the lower surface and are parallel with each other. In one or more alternate embodiments, the unit batteries 100 may have any other suitable shape, such as, for instance, cylindrical.

In one embodiment, the unit batteries 100 may be located side-by-side along one direction. For example, the unit batteries 100 may be oriented parallel with each other so that the third side of one of the unit batteries 100 and the fourth surface of an adjacent unit battery 100 face each other.

In one embodiment, the can 110 may be manufactured out of any suitable metal, such as, for instance, aluminum (Al) or an Al alloy. The metal may be selected such that the can 110 maintains its strength and shape against a fall. In an embodiment in which the can 110 includes metal and the unit batteries are located side-by-side in parallel, the unit batteries 100 may generate an unnecessary short through the shorter sides of the unit batteries 100. Thus, the sides of the unit batteries 100 that face each other may be electrically insulated from each other. For example, the third side and the fourth side of the neighboring batteries 100 may be covered by an insulating sheet 120, such as an insulating tape. In one or more alternate embodiments, the can 110 may be made out of any other suitable material.

A first electrode (hereinafter referred to as a negative electrode) and a second electrode (hereinafter referred to as a positive electrode) of the unit battery 100 may be formed on an upper surface of the unit battery 100, that is, the cap plate 112. In one embodiment, the negative electrode of the electrode assembly is electrically coupled to an electrode terminal 113 disposed on the cap plate 112, and the positive electrode of the electrode assembly is electrically coupled to the cap plate 112. Thus, the electrode terminal 113 may form a negative electrode of the unit battery 110 and the cap plate 112 may form a positive electrode of the unit battery 110. In one embodiment, the cap plate 112, like the body 111 of the can 110, may be made out of any suitable any suitable metal, such as, for instance, Al or an Al alloy. Therefore, in order to prevent an electrical short between the electrode terminal 113, which is a negative electrode, and the cap plate 112, which is a positive electrode, a gasket 114 may be interposed between the electrode terminal 113 and the cap plate 112, as illustrated in FIG. 2.

The connection substrate 200 electrically connects the plurality of unit batteries 110 to each other. The connection substrate 200 may connect the plurality of unit batteries 110 to each other in any suitable configuration, such as, for instance, in series, in parallel, or in series and parallel. The connection substrate 200 may be a printed-circuit board (PCB) on which a circuit pattern, for electrically coupling the unit batteries 100 to each other, is printed.

The first connection tabs 310 and the second connection tabs 320 electrically couple the connection substrate 200 to the unit batteries 100. A first end of each of the first and second connection tabs 310 and 320 may be connected to a respective unit battery 100, and a second end of each of the first and second connection tabs 310 and 320 may be connected to the substrate 200. For example, the first end of each of the first connection tabs 310 may be connected to the respective electrode terminals 113, which are the negative electrodes of the unit batteries 100, and the second ends of each of the first connection tabs 310 may be attached to the connection substrate 200. The first end of each of the second connection tabs 320 may be connected to the respective cap plates 112, which are the positive electrodes of the unit batteries 100, and the second end of each of the second connection tabs 320 may be attached to the connection substrate 200.

The unit batteries 100, which are electrically connected to the connection substrate 200 via the first and second connection tabs 310 and 320, are connected to each other in series, in parallel, or in series and parallel by using a circuit pattern that is formed on the connection substrate 200.

Since the connection substrate 200 includes a circuit pattern for electrically coupling the unit batteries 100 to each other, a metal plate for connecting the unit batteries 100 to each other in series or parallel does not need to be included. Thus, in one embodiment, an unnecessary wiring connection between the metal plates may be eliminated. The battery pack 10 may, however, include a separate metal plate for connecting the unit batteries 100 to each other and still fall within the scope and spirit of the present disclosure. Additionally, the unit batteries 100 may be electrically coupled to each other by connecting the first and second connection tabs 310 and 320 to the connection substrate 200 and connecting the first and second connection tabs 310 and 320 to the positive/negative electrodes of the unit batteries 100. The first and second connection tabs 310, 320 may be connected to the connection substrate 200 and the positive/negative electrodes of the unit batteries 100 by any suitable means, such as, for instance, bonding. Furthermore, in one embodiment, the connection substrate 200 is rigid and is disposed in parallel to an upper surface 110t of the unit batteries 100 such that the unit batteries 100 are configured to remain in their configuration (e.g., side-by-side) and to prevent a short between the unit batteries 100.

With continued reference to the embodiment illustrated in FIGS. 1-3, the protection circuit module 400 may be electrically coupled to the connection substrate 200. The protection circuit module 400 is electrically coupled to the plurality of unit batteries 100 via the connection substrate 200. The protection circuit module 400 is configured to prevent overheat or explosion that may be caused by the over-charge of the unit batteries 100, the over-discharge of the unit batteries 100, or excessive current supplied to or drawn from the unit batteries 100.

The protection circuit module 400 may include a substrate 410 and a protection device that is mounted at a side of or inside the substrate 410. The protection device may include a safety device that is formed of a passive device, such as a resistor or a capacitor, or an active device, such as a field-effect transistor, or integrated circuits. A connector 420 for supplying power to an external electronic device may be included at one side of the protective circuit module 400.

The protective circuit module 400 may be electrically connected to the connection substrate 200 via the leads 500. One end of the leads 500 may be connected to the protective circuit module 400, and the other end of the leads 500 may be connected to the connection substrate 200.

In one embodiment, the protective circuit module 400 and the connection substrate 200, shown in FIG. 2, may be bent as shown in FIG. 1. In the embodiment illustrated in FIG. 1, the protective circuit module 400 and the connection substrate 200 are disposed adjacent to a first side 110s1 and the upper surface 110t of the unit batteries 100, respectively. Thus, in the illustrated embodiment of FIG. 1, a space of the protective circuit module 400 and the connection substrate 200 in the battery pack 10 may be minimized, and thus the battery pack 10 may be manufactured to be compact. In one or more alternate embodiments, the protective circuit module 400 and the connection substrate 200 may have any other suitable configuration relative to each other, such as, for instance, parallel to each other, as shown in FIGS. 2 and 3.

In the embodiment illustrated in FIG. 1, the leads 500, which are disposed on and connected to a first surface 400a of the protective circuit module 400 and a first surface 200a of the connection substrate 200, are bent at an angle, such as, for instance, approximately 90 degrees. Accordingly, the protective circuit module 400 may be oriented parallel to a side of the unit batteries 100, for example, the first side 110S1 of the unit batteries 100.

As illustrated in FIGS. 2 and 3, the first and second connection tabs 310 and 320 are bent at an angle, such as, for instance, approximately 90 degrees. Accordingly, the connection substrate 200 may be oriented parallel with the upper surface 110t of the unit batteries 100. For example, as the first and second connection tabs 310 and 320 are bent, the connection substrate 200 may be bent so that the first surface 200a of the connection substrate 200 may face the upper surface 110t of the unit batteries 100.

The first connection tab 310 may include a temperature cutoff (TCO). In one embodiment, an end of the first connection tab 310, which is disposed on the connection substrate 200, may be divided into two parts, and the TCO may be interposed between the two parts.

The first and second connection tabs 310 and 320 may be disposed on and connected to the connection substrate 200 by using any suitable adhesive material, such as, for instance, an adhesive material that includes lead (Pb). One end of each of the first and second connection tabs 310 and 320 are connected to the negative electrode and the positive electrode of the unit batteries 100, respectively, and the other end of each of the first and second connection tabs 310 and 320 are attached to the connection substrate 200 using any suitable adhesive material. Since the ends of the first and second connection tabs 310 and 320 are bent, a center of gravity may be shifted toward one of the ends of the first and second connection tabs 310 and 320. When the center of gravity of the first and second connection tabs 310 and 320 is shifted towards one of the ends, the first and second connection tabs 310 and 320 may become dislocated from the connection substrate 200 or may not be suitably adhered to the connection substrate 200. For example, in one embodiment, the second connection tab 320 may be fixed to the connection substrate 200 by applying an adhesive material to the connection substrate 200, disposing the second connection tab 320 on the connection substrate 200, and then heating the second connection tab 320 by using heat or ultraviolet rays. However, if the center of gravity of the connection tab 320 is shifted towards the one end that is configured to be connected to the cap plate 112, the second connection tab 320 may not remain aligned at an appropriate location on the connection substrate 200.

However, as described in more detail below, according to one embodiment of the present disclosure, the other end of the second connection tab 320, which is fixed to the connection substrate 200, extends to or around one side of the connection substrate 200, as well as along the first surface 200a of the connection substrate 200, to balance the center of gravity of the second connection tab 320. In this manner, the potential misalignment between the second connection tab 320 and the connection substrate 200 may be prevented. Similarly, the connection tab 310 may tend to become misaligned relative to the connection substrate 200. Accordingly, the end of the first connection tab 310 that is fixed to the connection substrate 200 may be configured to extend to or around one side of the connection substrate 200, as well as along the first surface 200a of the connection substrate 200, to balance the center of gravity of the first connection tab 310. However, hereinafter, for convenience of explanation and to avoid duplicity, a detailed description will be provided only with regard to the second connection tab 320.

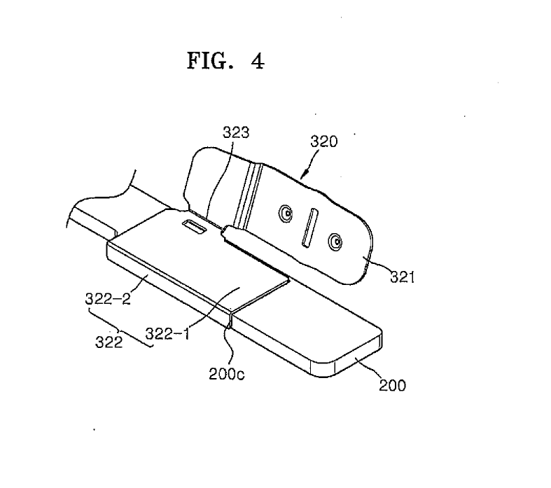

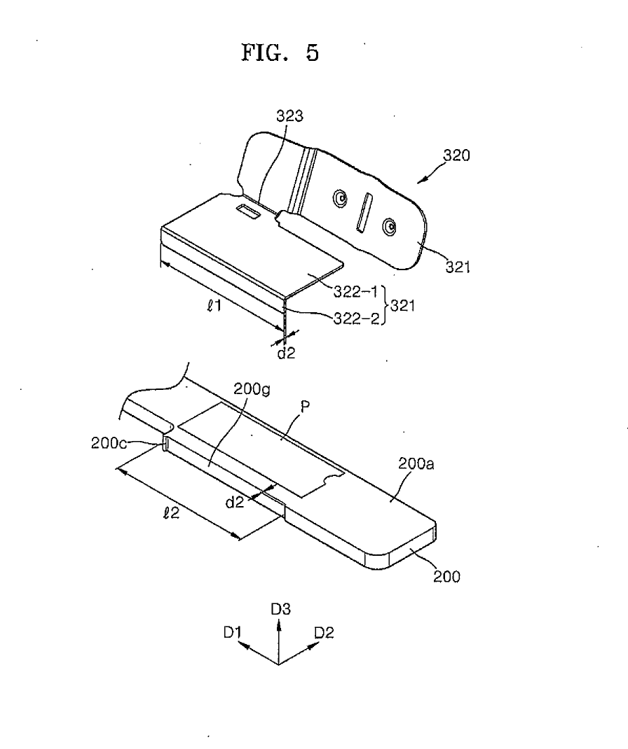

FIG. 4 is an enlarged perspective view of area IV shown in FIG. 3, and FIG. 5 is an exploded perspective view of FIG. 4.

Referring to FIGS. 4 and 5, the second connection tab 320 may include a connection part 321 that is formed at one end of the second connection tab 320, a fixing part 322 that is formed at the other end of the second connection tab 322, and a joint part 323 that couples the connection part 321 to the fixing part 322.

The connection part 321 is configured to be connected to the unit batteries 100, for example, to the cap plates 112 that are the positive electrodes of the unit batteries 100. The fixing part 322 is configured to be attached to the connection substrate 200. In one embodiment, the joint part 323 may integrally connect the connection part 321 to the fixing part 322 as a single unitary body. In an alternate embodiment, the connection part 321 and the fixing part 322 may be separately formed and joined together by the joint part 323. In one embodiment, the joint part 323 may be offset relative to an axis that passes through a center of the connection part 321 and the fixing part 322. For example, in the embodiment illustrated in FIG. 4, the joint part 323 couples a portion of a side of the connection part 321 and a portion of a side of the fixing part 322. In an alternate embodiment, the joint part 322 may extend along the full length of the side of the fixing part 322 and/or the connection part 321.

In one embodiment, after the connection part 321 is connected to the unit batteries 100 (e.g., the cap plates 112) and the fixing part 322 is attached to the connection substrate 200, the joint part 323 is bent. In an alternate embodiment, the joint part 323 may be bent before the connection part 321 is connected to the unit batteries 100 and/or before the fixing part 322 is attached to the connection substrate 200. Thus, as shown in FIG. 1, the first surface 200a of the connection substrate 200 may be disposed to face the upper surface 110t (see FIG. 2) of the unit batteries 100. Since the joint part 323 is bent, the connection part 321 and a first part 322-1 of the fixing part 322 may be disposed to face each other in parallel.

The fixing part 322 may include the first part 322-1 and a second part 322-2 that is bent to be approximately perpendicular to the first part 322-1. The first part 322-1 is configured to be attached to the first surface 200a of the connection substrate 200, and the second part 322-2 is configured to be attached to a side 200c of the connection substrate 200. Since the fixing part 322 of the second connection tab 320 includes the first part 322-1 and the second part 322-2 that is bent with respect to the first part 322-1, and the first part 322-1 and the second part 322-2 are respectively attached to the first surface 200a of the connection substrate 200 and the side 200c that is approximately perpendicular to the first surface 200a, the second connection tab 320 may be stably attached to the connection substrate 200, and the likelihood of dislocation or misalignment of the second connection tab 320 on the connection substrate 200 may be reduced.

As illustrated in FIG. 5, a connection pad P is included on the first surface 200a of the connection substrate 200, and thus the connection substrate 200 may be electrically connected to the first part 322-1 of the connection tab 320. As described above, the connection substrate 200 may be manufactured as a PCB that includes a circuit pattern for connecting the unit batteries 100 to each other in series, in parallel, or in series and parallel. In one embodiment, a part of the circuit pattern may be exposed on the first surface 200a of the connection substrate 200, thus forming the connection pad P.

With continued reference to the embodiment illustrated in FIG. 5, a groove 200g may be formed along the side 200c of the connection substrate 200. In one embodiment, the shape and size of the groove 200g may correspond to the shape and size of the second part 322-2 of the fixing part 320. In particular, a groove length I1 in the direction of D1 may be formed to be substantially identical to a length I2 of the second part 322-2. Additionally, a groove depth d1 may be formed to be substantially identical to a depth d2 of the second part 322-2. Thus, the second connection tab 320 may be stably placed on the connection substrate 200 by inserting the second part 322-2 of the second connection tab 320 into the groove 200g in the connection substrate 200. With such a configuration, the likelihood of dislocation of the second connection tab 320 from the connection substrate 200 may be reduced, and the second connection tab 320 may be easily aligned relative to the connection substrate 200.

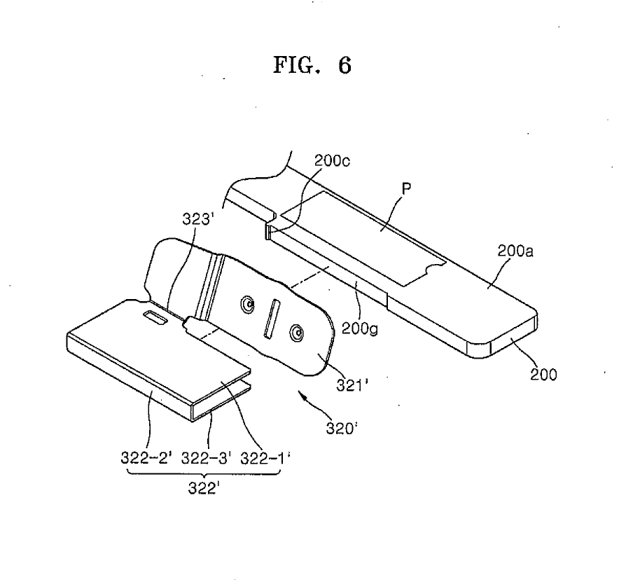

FIG. 6 is a schematic exploded perspective view of the connection substrate 200 and a second connection tab 320′, according to another embodiment of the present disclosure.

Referring to FIG. 6, as described above, the second connection tab 320′ may include a connection part 321′ that is formed at one end of the second connection tab 320′, a fixing part 322′ that is formed at the other end of the second connection tab 320′, and the joint part 323′ that connects the connection part 321′ to the fixing part 322′. The connection part 321′ is configured to be connected to the cap plates 112 that are the positive electrodes of the unit batteries 100, and the fixing part 322′ is configured to be attached to the connection substrate 200. In one embodiment, the joint part 323′ may integrally connect a side of the connection part 321′ and a side of the fixing part 322′ to each other as a single unitary body.

Additionally, in one embodiment, after the connection part 321′ is connected to the unit batteries 100 (e.g., the cap plates 112) and the fixing part 322′ is attached to the connection substrate 200, the joint part 323′ is bent. In an alternate embodiment, the joint part 323′ may be bent before the connection part 321′ is connected to the unit batteries 100 and/or before the fixing part 322′ is attached to the connection substrate 200. Thus, as shown in FIG. 1, the first surface 200a of the connection substrate 200 may be disposed to face the upper surface 110t of the unit batteries 100. Since the joint part 323′ is bent, the connection part 321′ and a first part 322-1′ of the fixing part 322′ may be disposed to face each other in parallel.

In the embodiment illustrated in FIG. 6, the second connection tab 320′ may include the first part 322-1′ and a second part 322-2′ that is bent approximately perpendicular with respect to the first part 322-1′, and a third part 322-3′ that is bent approximately perpendicular with respect to the second part 322-2′ and is substantially parallel with the first part 322-1′.

The first part 322-1′ is configured to be attached to the first surface 200a of the connection substrate 200, and the second part 322-2′ is configured to be attached to the side 200c of the connection substrate 200. The third part 322-3′ of the second connection tab 320′ is configured to be attached to a second surface 200b (shown in FIG. 1) opposite to the first surface 200a′ of the connection substrate 200. Since the fixing part 322′ of the second connection tab 320′ includes the first part 322-1′, the second part 322-2′ that is bent with respect to the first part 322-1′, and the third part 322-3′ that is bent with respect to the second part 322-2′, the second connection tab 320′ may be stably attached to the connection substrate 200 and therefore the likelihood of dislocation or misalignment of the second connection tab 320′ on the connection substrate 200 may be reduced.

As illustrated in FIG. 6, the connection pad P is included on the first surface 200a of the connection substrate 200, and thus the connection substrate 200 may be electrically connected to the first part 322-1′ of the second connection tab 320′. The connection pad P may be formed when a part of a circuit pattern of a PCB, which forms the connection substrate 200, is exposed on the first surface 200a of the connection substrate 200.

As illustrated in FIG. 6, the groove 200g may be formed along the side 200c of the connection substrate 200. In one embodiment, the shape and size of the groove 200g in the connection substrate 200 may correspond to the shape and size of the second part 322-2′ of the second connection tab 320′. Thus, the second connection tab 320′ may be stably placed on the connection substrate 200 by inserting the second part 322-2′ of the second connection tab 320′ into the groove 200g. With such a configuration, the likelihood of dislocation of the second connection tab 320 from the connection substrate 200 may be greatly reduced, and the second connection tab 320′ may be easily aligned with the connection substrate 200.

Although the battery pack 10 has been described above with reference to the second connection tab 320 and 320′, as illustrated in FIGS. 4 through 6, the present disclosure is not limited thereto. In one embodiment, the other end of the first connection tab 310 may extend to the side 200c of the connection substrate 200, as well as along the side 200a of the connection substrate 200, like the second connection tab 320. In another embodiment, the other end of the first connection tab 310 may extend along the first surface 200a, the first side 200c and the second surface 200b of the connection substrate 200, like the second connection tab 320′.

As described above, according to the one or more of the above embodiments of the present disclosure, at least one of the first and second connection tabs 310 and 320 extends to a side of the connection substrate 200, as well as along the first surface of the connection substrate 200. Thus, misalignment of the first or second connection tab 310 or 320, which is caused by a shift of a center of gravity when the first and second connection tabs 310 and 320 are attached to connection substrate 200, may be prevented. Additionally, the unit batteries 100 may be stably electrically coupled to each other.

It should be understood that the exemplary embodiments described herein should be considered in a descriptive sense only and not for purposes of limitation. Descriptions of features or aspects within each embodiment should typically be considered as available for other similar features or aspects in other embodiments. The scope of the present disclosure should not be limited to the foregoing discussion, but should be defined by the appended claims. Additionally, although relative terms such as “outer,” “inner,” “upper,” “lower,” “below,” and “above,” and similar terms have been used herein to describe a spatial relationship of one element to another, it is understood that these terms are intended to encompass different orientations of the various elements and components of the device in addition to the orientation depicted in the figures.

What is claimed is:

1. A battery pack comprising:
a plurality of unit batteries located side-by-side;
a connection substrate for connecting the unit batteries to each other in at least one of series and parallel;
a protection circuit module electrically coupled to the connection substrate; and
a first connection tab and a second connection tab located on the connection substrate and electrically coupling each of the unit batteries to the connection substrate,
wherein at least one of the first connection tab and the second connection tab includes one end that is connected to the unit batteries and one other end that is attached to a first surface of the connection substrate and a side of the connection substrate that is approximately perpendicular to the first surface.

2. The battery pack of claim 1, wherein the connection substrate comprises a circuit pattern for coupling the unit batteries to each other in at least one of series and parallel, and a part of the circuit pattern is exposed on the first surface of the connection substrate so as to form a connection pad.

3. The battery pack of claim 2, wherein a part of the other end of the at least one of the first connection tab and the second connection tab, which is attached to the first surface of the connection substrate, is attached to the connection pad.

4. The battery pack of claim 1, wherein a part the other end of the at least one of the first connection tab and the second connection tab is attached to the first surface of the connection substrate by an adhesive material comprising lead (Pb).

5. The battery pack of claim 1, wherein the at least one of the first connection tab and the second connection tab comprises:
a connection part that is connected to the unit batteries;
a fixing part which comprises a first part that is attached to the first surface of the connection substrate, and a second part that is perpendicular to the first part and attached to the side of the connection substrate; and
a joint part that connects the connection part to the fixing part.

6. The battery pack of claim 5, wherein the first surface of the connection substrate comprises a connection pad and the first part of the fixing part is attached to the connection pad.

7. The battery pack of claim 5, wherein the joint part is bent so that the first surface of the connection substrate and an upper surface of the unit batteries, to which the connection part is attached, face each other.

8. The battery pack of claim 5, wherein the joint part is offset toward one side of an axis that passes through a center of the connection part and the fixing part, and the joint part couples the connection part and the fixing part together as one unitary body.

9. The battery pack of claim 5, wherein the fixing part further comprises a third part that is bent to be approximately perpendicular to the second part of the fixing part and wherein the third part is attached to a lower surface of the connection substrate.

10. The battery pack of claim 5, wherein the connection substrate further comprises a groove formed in the side of the connection substrate, and wherein the groove corresponds to the second part of the fixing part and accommodates the second part.

11. A battery pack comprising:
a plurality of unit batteries that respectively comprise a first electrode and a second electrode on an upper surface, and are located side-by-side;
a connection substrate for electrically coupling the unit batteries to each other;
a protection circuit module that is electrically coupled to the connection substrate; and
a first connection tab located on the connection substrate and electrically coupling the first electrode to the connection substrate; and
a second connection tab located on the connection substrate and electrically coupling the second electrode to the connection substrate,
wherein the second connection tab comprises:
a connection part that is connected to the second electrode; and
a fixing part that is attached to the connection substrate, and
wherein the fixing part comprises a first part that is attached to a first surface of the connection substrate, and a second part that is bent to be approximately perpendicular to the first part and is attached to a side of the connection substrate.

12. The battery pack of claim 11, wherein the connection substrate comprises a circuit pattern for connecting the unit batteries to each other in at least one of series and parallel, and a part of the pattern is exposed on the first surface of the connection substrate so as to form a connection pad.

13. The battery pack of claim 12, wherein the first part of the fixing part is attached to the connection pad.

14. The battery pack of claim 13, wherein an adhesive material comprising lead (Pb) is interposed between the first part and the connection pad.

15. The battery pack of claim 11, wherein the connection substrate further comprises a groove formed in the side of the connection substrate, and wherein the groove accommodates the second part.

16. The battery pack of claim 11, wherein the second connection tab comprises a joint part that is bent so that the connection substrate is located on the unit batteries and wherein the joint part couples the connection part and the fixing part.

17. The battery pack of claim 16, wherein the joint part is bent so that the first surface of the connection substrate and an upper surface of the unit batteries face each other.

18. The battery pack of claim 11, wherein the fixing part further comprises a third part that is bent to be approximately perpendicular to the second part and wherein the third part is attached to a second surface of the connection substrate that is opposite the first surface of the connection substrate.

19. The battery pack of claim 11, wherein the first electrode is a negative electrode of the unit batteries, and the second electrode is a positive electrode of the unit batteries.

20. The battery pack of claim 11, wherein the protection circuit module is bent to be approximately perpendicular to the connection substrate and adjacent to a side of the unit batteries.
